(19) United States
(12) Patent Application Publication
(10) Pub. No.: US 2012/0248068 A1
(43) Pub. Date: Oct. 4, 2012

(54) Process Module for the Inline-Treatment of Substrates

(75) Inventors: Frank Schienle, Freiburg (DE); Mario Schwab, Freiburg (DE); Rahim Hamid, Freiburg (DE); Lothar Hermann, Hornberg (DE); Günter Schwab, Neuotting (DE); Thomas Buschhardt, Burghausen (DE); Diego Feijóo, Burghausen (DE); Konrad Kaltenbach, Furtwangen (DE); Franz Sollinger, Polling (DE)

(73) Assignees: SILTRONIC AG, München (DE); RENA GMBH, Gütenbach (DE)

(21) Appl. No.: 13/378,357

(22) PCT Filed: Jun. 14, 2010
(86) PCT No.: PCT/EP10/03543

§ 371 Date: Jun. 18, 2012

(30) Foreign Application Priority Data
Jun. 19, 2009 (DE) 10 2009 029 945.9

(51) Int. Cl. B08B 3/08; B44C 1/22

(52) U.S. Cl. 216/83; 156/345.11; 134/122 R; 134/15

(57) ABSTRACT

The present invention relates to an apparatus and a method for the fluidic inline-treatment of flat substrates with at least one process module. In particular, the invention relates to such a treatment during the gentle and controlled transport of the substrates, wherein the treatment can also just relate to the transport of the substrates.

According to the invention, a process module 1 is provided which comprises a treatment chamber 2 having at least one treatment surface 7A being substantially horizontally arranged in a treatment plane 5 and being designed for the formation of a lower fluid cushion 6A, wherein two openings in the form of entry 3 and exit 4 for the linear feed-through of the substrates 22 in the same plane are assigned to the treatment surface 7A, and at least one feed device with at least one catch 10 for the controlled feed 9 of the substrates 22 within the treatment chamber 2.

Furthermore, the invention provides a method using the apparatus according to the invention.

The present invention relates to an apparatus and a method for the fluidic inline-treatment of flat substrates, wherein the treatment comprises common wet chemical process steps as well as, in particular, the gentle and controlled transport.

Plants for the treatment of flat substrates such as e.g. silicon wafers are known from the art. Mostly, such plants are intended for the wet treatment of the often fragile substrates. For example, the wet treatment can be a chemical surface modification, or a mechanical surface treatment for cleaning. Such a plant which is designed as process tank is disclosed in document DE 199 34 300 C2. The process tank which is described therein has two permanently opened openings through which the substrate to be treated can be linearly transferred. The interior of the process tank is filled with treatment liquid in such a manner that the substrate is completely and on both sides (bilaterally) surrounded by liquid at any time, which is why the openings are arranged below the liquid level. A device for ultrasonic treatment is arranged in the interior of the process tank. A vacuum which is transmitted into the treatment liquid is applied to the interior of the process tank above the liquid level in order to avoid the flowing off of the treatment liquid from the openings at both sides. A catchment channel, a droplet separator, and/or a drying chamber by which a fluid that is lowering the surface tension of the treatment fluid can be introduced, is arranged at the exit in order to catch liquid which still escapes from the tank or which is carried over by the exiting substrate.

Firstly, this state of the art has the disadvantage that dirt particles which are located outside the process tank can be unintentionally sucked into the interior of the process tank by the vacuum. Under certain conditions, the pressure ratios must continuously be adjusted in order to achieve an optimal relation between substrate thickness and pressure ratios of the tank interior. Cleaned treatment liquid must continuously be introduced from below into the process tank in order to avoid contamination of the substrates and to achieve a good circulation of the treatment liquid. The transport of the substrates, which is described in detail in the simultaneously filed application DE 199 34 301 A1, takes place by means of grippers which bear against various spots of the substrate and move the substrate first pushing, then pulling through the treatment chamber. Additionally, laterally arranged contact areas are provided for the lateral guidance of the substrate, wherein these guides are arranged at the same height as feed in and feed out devices which are located in front of and behind the treatment chamber. Such an arrangement results in respective mechanical contacts between substrate and transport device that can lead to damages up until destruction of the fragile substrates.

The object of the invention is therefore to provide an apparatus and a method to overcome the described disadvantages of the art. In particular, the invention shall enable an, optionally, double sided, and homogeneous treatment of substrates in a simple manner, wherein the effort which is necessary in view of the avoidance of contaminations should be as small as possible. Furthermore, the invention shall enable a high purity treatment of substrates, thus ensuring that the drag-in of particles into the interior of the process chamber, as well as a re-contamination of the substrates by already cleaned away particles or constituents inside the chamber is largely excluded. Further, the invention shall enable a particularly gentle transport of the substrates before, during, and after the treatment, wherein the treatment can also just relate to the transport of the substrates.

The object is solved by the features of the apparatus according to the invention as defined in claim 1, as well as by the features of the method according to the invention as defined in claim 14.

Preferred embodiments of the present invention are to be taken from the dependent claims as well as from the following detailed description and the figures.

The invention relates to an apparatus for the fluidic inline-treatment of flat substrates with at least one process module. In particular, the invention relates to such a treatment with the gentle and controlled transport of the substrates. The term “inline-treatment” means the continuous treatment of a multitude of substrates, wherein a series of substrates being arranged after one another in a row is linearly transported while passing one or several process stations. An “inline-treatment” has to be differentiated from a “batch treatment” which is particularly common in the field of wafer processing, wherein the substrates to be treated are not continuously fed into the respective treatment plant and subjected to the treatment, but in charges as “batches”. Although batch-plants provide the high throughputs which are mandatory in view of increasing the commercial viability, they have a number of disadvantages as well. For example, batch-plants lack a possibility of directly influencing the treatment of the substrate surface (e.g. by means of a megasound treatment, or by influencing the stream conditions), so that the risk of different process results between different substrates of a treatment charge's batch exists. A further problem can result from different process times of the substrate top and bottom edge, respectively, when vertically immersing into a process tank. Due to these reasons, the inline-treatment becomes increasingly preferred. The substrates can consist of any materials. However, such materials are preferred that are suitable for the production of electronic structures or for the generation of solar energy, such as semiconducting materials (e.g. silicon, silicon-germanium, germanium, gallium arsenide, gallium nitride, silicon carbide, possibly also as layers on suitable carrier materials), glass, ceramics, or plastics. Particularly preferred, the preferably round or angular substrates have a plane (flat) shape or at least a plane lower side which is necessary in order to enable a most gentle transport, which is explained in more detail hereinafter. The substrates typically have a diameter or edge length of 300 to 400 mm, although they can also be smaller or, preferably, bigger. The fluidic treatment can be each type of treatment, wherein the apparatus according to the invention is particularly suitable for the treatment with liquids. However, also gases can be used for the treatment, and the treatment can be supplemented by or only comprise further processes such as e.g. cleaning steps.

For the avoidance of undesired rejects during the treatment of substrates, their gentle transport is of major importance. In particular, the functional surfaces of the substrates, such as e.g. the upper and lower sides of silicon wafers, should not be mechanically contacted at any time in order to avoid damages and/or contaminations of the surfaces. A mechanical contact is caused e.g. by a transport with rollers, grippers, slide tracks, and the like. However, no mechanical contact of these functional surfaces results from the transport with a fluid as intended by the invention, as long as this fluid is accordingly pure and does not contain any particles which could exert an abrasive effect. A further risk due to mechanical damage results from the impulsive contacting of the edges of the substrates. In extreme cases, such contactings can result in split-offs of the substrate material. Besides the damage of the substrate, the splinters can also result in damages of further substrates if no appropriate filtering takes place. These impulsive contactings of substrate edges as often encountered in the art are due to the provision of lateral end stops, guiding edges and the like, that shall prevent the substrates from laterally being thrown off their transport or treatment track.

The precise reproducibility of the treatment process is also essential for an economic treatment and a high-quality treatment result. The treatment duration, i.e. the residence time of a substrate in the treatment region of a treatment chamber, is an important parameter within the context of an inline-treatment. In particular, this is the case in all wet chemical processes. It is therefore indispensable to provide a precisely adjustable and controllable feed which in particular determines the position of the substrates, viewed in transport direction, between entry and exit.

According to the invention, the apparatus comprises at least one process module with a treatment chamber for the treatment of the substrate(s). As per definition, the term “treatment” also includes the substrate transport as such, and it can, in certain cases, also exclusively relate to the transport. The treatment chamber has at least one treatment surface being substantially horizontally arranged in a treatment plane. The treatment plane is the plane in which the usually flat formed substrates are transported and treated, wherein it may be provided that a substrate within the treatment chamber temporarily leaves the treatment plane. However, not later than immediately before leaving the treatment chamber, the substrate must be re-located in the treatment plane. According to the invention, the treatment surface is designed for the formation of a lower fluid cushion provided to support the substrates without mechanically contacting the treatment surface. Two openings for the linear feed-through of the substrates in the same plane are assigned to the treatment surface as entry and exit for feeding in and leaving the treatment chamber. In other words, the respective entry and exit is each located in a common treatment plane. According to the invention, it may be provided that a treatment chamber has several, e.g. adjacently arranged entries and/or exits; in particular, if a treatment chamber comprises several tracks for the parallel treatment of substrates. Further, it may be provided according to the invention that the treatment chamber comprises several treatment planes, wherein it is usually preferred that all treatment planes are arranged coplanar. It is also possible that several entries and only one common exit are provided, so that initially different treatment tracks are brought together. The length of the treatment chamber, viewed in transport direction, is chosen depending on the desired feed velocity and the required treatment duration.

Further, the treatment chamber according to the invention comprises at least one feed device with at least one catch for the controlled feed of the substrates within the treatment chamber. Regarding the importance of a gentle and controlled treatment, reference is made to the aforementioned explanations. The task of the transport which is comprised by the treatment can be subdivided into the subtasks “feed”, “support”, and “guiding”. The feed device according to the invention has the task of “feed” and “guiding”.

The task of gentle “support” is, according to the invention, solved by a further element of the apparatus according to the invention. For this, the treatment chamber of each process module comprises a treatment surface being substantially horizontally arranged in a treatment plane and being designed for the formation of a lower fluid cushion provided to support the substrates without mechanically contacting the treatment surface. A treatment surface according to the invention has outlet openings through which fluid can be emitted. The exit openings are thus pressurized with a fluid having at least slight overpressure, and which normally is a liquid. Due to the emitting, a stable and more or less thick liquid layer develops on the treatment surface. According to the invention, this liquid layer supports the substrate. This also happens in a particularly gentle manner, since the support and (with simultaneous feed) also the transport of the substrate take place without any mechanically contacting of the respective treatment surface. According to a preferred embodiment, the apparatus according to the invention further comprises a further surface being arranged above and parallel to the treatment surface and being designed for the formation of an upper fluid cushion.

Further, the process module of the apparatus according to the invention comprises at least one drive chamber being separated from the treatment chamber and having drive elements for the feed device, provided that the drive elements are not already entirely arranged within the treatment chamber, particularly as integral components of one or several treatment surfaces or of the lateral walls of the chamber. In the context of corresponding embodiments of the apparatus according to the invention, the drive elements of the feed device are thus arranged outside the treatment chamber in a separate and optionally rinsable drive chamber. In this way, it can be ensured that abrasion of movable parts such as bearings and guides cannot even enter the actual treatment chamber from which it could only barely be removed again. Undesired particles are removed from the drive chamber as well before they enter the treatment chamber, e.g. via bore holes of drive shafts or the like, by the rinsing according to the invention with rinsing gas, cleaning liquid, or, particularly preferred, with water.

As already mentioned before, the treatment chamber comprises at least one device for the controlled feed of the substrates (herein also briefly referred to as “feed device”) with at least one catch, so that the apparatus can ensure the gentle and controlled feed of the substrate being necessary according to the invention. According to the invention, this feed device can be provided in several embodiments, wherein a general differentiation is made between a feed device that acts from above, from below, or from the side onto the edge of the substrate.

According to a first embodiment, the feed device, including its at least one catch, is arranged above the treatment plane, and the catch(es) is or are designed in such a manner that the edge of the substrate to be treated can be contacted by their respective end(s). In the context of this embodiment, the feed device can be designed as a separate structural component, or as an integral element of an optional further treatment surface being present above the treatment surface for the formation of an upper fluid cushion. Provided that the feed device is designed as a separate structural component, the further treatment surface preferably has gaps for the at least one catch so that the same can permanently contact the substrate edge during its transport through the treatment chamber.

According to a second embodiment, the feed device, including its at least one catch, is arranged below the treatment plane as an integral component of the treatment surface for the formation of the lower fluid cushion.

According to a third embodiment, the feed device, including its at least one catch, is arranged parallel to the feed direction and lateral to the treatment plane as an integral component of the lateral wall of the treatment chamber.

It is clear to the one skilled in the art that these basic embodiments can be combined according to the invention with each other, depending on the actual field of application.

According to the invention, each of the above embodiments can be realized not only with a single, but preferably with two feed devices which most preferably are designed identical.

In the context of the above first embodiment, the feed device is therefore designed as a separate structural component preferably two-part, wherein each part has at least one catch. The multipart design is particularly required or advantageous, when several treatment chambers are switched one after another and the treatment chambers exceed a certain minimum length. A multi- and in particular a two-part feed device is also necessary when the next substrate shall be fed into the treatment chamber while the previous substrate is still partially located in the treatment chamber. The multipart design of the feed device means that it consists of at least two assemblies which substantially fulfil identical tasks, thus having a substantially identical design. The most essential difference between the parts is their positioning in the interior of the treatment chamber. Usually, one part of a multipart feed device will be arranged in the entry region of the treatment chamber, while a further part is located in the exit region of the treatment chamber. Accordingly, the one part is used primarily for the feed of the substrate in the entry region, while the other part is used for the feed in the exit region. If the process module comprises several treatment planes or treatment tracks, one or several individual feed devices can be provided for each of these treatment tracks. However, it is preferred to combine the parts of the feed devices as far as possible, which is always easy to realize when synchronized treatment and transporting on parallel tracks is desired.

Alternatively, the above first embodiment comprises a single part feed device as separate structural component, which is preferably arranged, in respect of the length of the treatment plane of a treatment chamber, roughly in the centre of the same. In order to guarantee a continuing contact of the catch(es) to the substrate edge, these are preferably designed telescopic. It is thus ensured that the catches can contact the substrate edge always at the height of the treatment plane.

According to the invention, each part of a multipart feed device comprises catches. Therein, according to the invention, only the catches are in direct contact with the substrate. Further, the catches are designed and arranged in such a manner that the substrate can also be guided by them. In other words, each part of the multipart feed device serves not only for the feed of the substrate, but also for keeping the track of the same on its path through the treatment chamber. Each part of a one- or multipart feed device does not require lateral limiters or end stops, so that the aforementioned risk of impulsive loads onto the substrate is not present, as will be explained hereinafter.

In the context of the above first and second embodiment, the feed device preferably has, as integral component of the lower or upper treatment surface, a multi-, and in particular, a two-part design, wherein each part comprises two catches which are arranged parallel to each other and, preferably, in a certain distance to each other. Also here, the one part is arranged rather at the entry, and the other part is arranged rather at the exit of the treatment chamber. The respective catches of the parts can be extended from the treatment surfaces, thus contacting the substrate edge, which preferably takes place in a synchronized manner. The catches can be retracted into the respective, treatment surface after the intended feed has taken place.

In the context of the above-mentioned third embodiment, the feed device is designed as integral component of the lateral walls of the treatment chamber, and therefore two-part (on both sides). As explained before, the catches can be extended laterally from the respective wall so that they contact the substrate edge, which preferably also takes place in a synchronized manner.

According to the invention, it is preferred that the velocity of the feed which points in the respective feed direction can be adjusted in such a manner that, in cooperation with the flow velocity of the fluid cushion, this results in that the substrate is permanently pressed against the catch(es) of the feed device, so that it is therefore avoided that the substrate departs in an uncontrolled manner from the catch or the catches. In order to generally describe this, the term of a holding direction is defined: in the following, the holding direction is to be understood as the direction of a vector representing the sum of those vectors which point from one respective catch in the plane of the substrate towards the centre of gravity of the substrate, as being depicted in FIGS. 7A to 7D. FIGS. 7A and 7C schematically show a top view on two exemplary arrangements of a substrate 22 and two catches 10, wherein the vector of the holding direction h is also depicted. Thus, the holding direction h always points from the region of the substrate edge onto which the catch 10 acts to the centre of the substrate 22. In the case of several catches 10, the holding direction results from a vector addition of the according individual unit vectors. Thus, the holding direction also gives the direction in which forces can act from the catches onto the substrate.

FIGS. 7A and 7C also show exemplary vectors of the feed velocity V_{V} and the flow velocity V_{F}. FIGS. 7B and 7D show the according vectors in a polar coordinate system. The feed velocity V_{V}, i.e. the speed with which the feed device is being moved, as well as the flow velocity V_{F} of the fluid cushion, can have a component in direction of the holding direction h. If the holding direction and the according velocity component are identically directed (such as e.g. in the case of the feed velocity V_{V} in FIGS. 7A and 7B), the velocity component has a positive sign. If they are counter-directed (such as e.g. in the case of the flow velocity V_{F} in FIGS. 7A and 7B, as well as the feed velocity V_{V} and the flow velocity V_{F} in FIGS. 7C and 7D), the velocity component has a negative sign. If the velocity is directed perpendicular to the holding direction, its component in holding direction is zero.

Preferably, the feed velocity V_{V} and the flow velocity V_{F} of the fluid cushion can be coordinated in a vectorial sense in such a manner that the component of the feed velocity V_{V} in holding direction exceeds the component of the flow velocity V_{F} of the fluid cushion in holding direction. Mathematically, this can be expressed by the condition V_{V}·h>V_{F}·h, i.e., the scalar product of the vectors of the feed velocity V_{V} and the holding direction h must, with regard to the sign, be greater than the scalar product of the vectors of the velocity V_{F} of the fluid cushion and the holding direction h.

It is not preferred, but also not excluded, that the flow velocity of the fluid cushion has a component which points in transport direction of the substrate. Without the feed device according to the invention, the substrate would drift in an uncontrolled manner in direction of or with the flow, so that no precisely defined period of treatment of the substrate would be achievable. This situation does not change even if the feed device transports slower than the component of the fluid of the fluid cushion which points in transport direction. The substrate would depart in an uncontrolled manner from the catches. Only if he above described condition is fulfilled, a contact of the respective catches with the edge of the substrate is ensured at any time. Only one circumferential edge exists in the case of a round substrate; the catches push the substrate preferably in its back region in transport direction. The back region is the region of the edge which points in direction of the entry opening and is defined in that a cutting plane which is perpendicular to the transport direction and runs through the centre of the substrate divides the round substrate in two halves. In the case of a rectangular, such as, in particular, a square substrate, it is preferred that, when viewed from above, the same is transported while being rotated through 45 degrees so that its diagonal points in transport direction. In this way, a taper is provided which is located behind the centre of the square substrate, and whose edges can be contacted by the catches according to the invention in a manner according to the invention. Of course, it is also possible to transport a substrate which is aligned parallel to the transport direction; however, the risk exists of a lateral drifting-off of the substrate from the pre-determined track if the static friction between catches and substrate becomes smaller than the cross flow components, which can develop e.g. due to transport related flow separations, and which can laterally act onto the substrate and attempt to push the same off-track.

Further, a device for media separation is assigned to at least one of the two entry and exit openings of the apparatus according to the invention. The media separation is therefore arranged in the region of the entry and/or of the exit. The media separation alternatively serves for the separation of surplus treatment liquid from the substrate when leaving the treatment chamber, or for a gas treatment of the substrate surface. However, the media separation or gas treatment can also be provided for the removal of undesired treatment liquid, or for the surface modification prior to the entry of the substrate into the treatment chamber, for what the media separation must accordingly be arranged in the entry region of the treatment chamber. In this way, a contamination of the treatment liquid which is provided in the treatment chamber is avoided, or can at least be reduced. Summarizing, the media separation serves for an avoidance of the carrying-over of media between individual process modules and/or for a gas treatment of the substrate surfaces.

As already mentioned, the apparatus according to the invention particularly serves for the production or the processing of electronic products or solar cells. Since in such an environment any contaminations can quickly result in damages up until destruction of the products, it is preferred according to the invention that the interior of the treatment chamber is sealed against the exterior, except for the openings (the at least one entry and exit). For this, passive methods known from the art such as e.g. the usage of seals, but also active methods such as e.g. the provision of a treatment chamber atmosphere of high purity protective gas, and/or the pressurization of the interior of the treatment chamber with a slight overpressure, come into question.

According to a further and particularly preferred embodiment, the treatment chamber according to the invention has a further surface being arranged above and parallel to the treatment surface and being designed for the formation of an upper fluid cushion. Accordingly, preferably two sandwich-like fluid cushions, and therefore, two treatment surfaces facing each other and enclosing the treatment plane are present in the treatment chamber. In this way, the substrate is gently supported on both sides, wherein the substrate has no mechanical contact with one of these areas in this embodiment as well. A contamination by falling down particles is excluded to a large extent. Furthermore, the substrate is held and transported more securely by the support on both sides. Furthermore, the upper fluid cushion also allows for a targeted distribution of the liquid onto the substrate surface, or for an additional effect of the liquid e.g. by a relative motion.

Alternatively, also another device that can provide fluid as, in particular, liquid, such as e.g. a spatter strip, can be provided and arranged above the treatment plane, wherein it is not mandatory that this device covers the entire transport path through the treatment chamber.

In case of the provision of an upper fluid cushion, depending on the concrete embodiment of the feed device, it can be preferably be intended that the further surface which generates the upper fluid cushion provides gaps for the at least one catch. These gaps are functionally decoupled from the fluid emitting outlet openings and serve for the purpose that a catch which operates from above can, on its way in feed direction, always securely contact the edge of the substrate. In the case of the presence of a multi- such as e.g. two-part feed device, the upper treatment surface would accordingly provide several such as e.g. two gaps.

The number of gaps in the treatment surface(s) usually corresponds to the number of parts of a feed device according to the invention, as well as to the respective number of catches of a part. The gaps run according to the movements which the catch(es) must perform, and, in the case of at least two catches per part, they are aligned substantially parallel to each other. According to a preferred embodiment, the gaps for one respective part of a multi-, such as, in particular, a two-part feed device with at least two catches, are spaced apart from each other perpendicular to the transport direction, wherein, in the case of a two-part feed device, the respective distance is particularly preferred different in such a manner that a contacting of the catches of different parts is excluded. In particular, this is necessary if the substrate shall be handed over from the catches of a first part to the catches of a further part of a multi-, such as, in particular, a two-part feed device. Accordingly, the gaps for the catches of a multi-, such as, in particular, a two-part feed device, are arranged in the treatment surface(s) in such a manner that a contact of the catches of different, but cooperating parts is excluded. In the case of a single part feed device, independent of the concrete embodiment, preferably at least two catches are provided whose distance to each other varies in transport direction. While the catches are further spaced apart in their position at the entry of the treatment chamber in order to ensure a most possible early reception of a fed in substrate, it is advantageous if the distance of the catches decreases in direction to the exit, so that the substrate can be fed out from the chamber as far as is possible.

According to a particularly preferred embodiment, the apparatus according to the invention comprises a device for emitting treatment fluid onto the substrate side which faces upwards. Accordingly, treatment liquid can be emitted from at least one of the possibly several fluid cushions, so that the substrate is simultaneously supported and treated by the according fluid. It is also possible that the entire treatment plane comprises several and separately feedable fluid cushions of which some emit a treatment fluid, others emit a neutral fluid, and yet others emit a cleaning fluid.

Preferably, the treatment surface which forms the lower fluid cushion and the optional further surface which is optionally provided for the formation of the upper fluid cushion comprise rows of boreholes which are respectively arranged mirror-invertedly parallel to the feed direction and which serve as outlet openings. In other words, the rows run parallel to each other in feed direction, and they are evenly distributed on both sides of a treatment surface. The boreholes are located in the treatment surface of the fluid cushion. Preferably, they can stand vertically in the treatment surface, but it can be advantageous if they have an inclination in or against the feed direction. This inclination produces a flow in, perpendicular to, or against the transport direction, which can be advantageous in certain cases. A flow which is directed against the transport direction serves for ensuring a secure contact of the substrates to the catches at any time, particularly in the case that a slow feed motion or, temporarily, no feed motion at all is desired. Furthermore, a reverse-directed flow of the fluid cushion avoids a re-adsorption of already cleaned-away contaminants. However, the same effect of avoiding a re-contamination can be achieved by a forward-directed flow. Further, it may be provided that the boreholes have a lateral tilt, resulting in a flow to or away from the centre line of the treatment plane, respectively. Finally, it may be provided that the fluid cushion according to the invention has at least one region which consists of a highly porous material and which e.g. is made of sintered material, and that further, one common or several separately driveable media inflows are assigned to the boreholes or the at least one region of highly porous material. In this way, it is made possible to differently feed certain regions with different media such as treatment, transport, and/or cleaning fluids. The treatment surfaces for the formation of a fluid cushion can e.g. be designed according to EP 650455 B1 or EP 650456 B1.

As already mentioned, each of the at least one feed device or each part of a multi-, and in particular, a two-part feed device, has at least one catch. Preferably, the apparatus according to the invention has two catches which are particularly preferred identically designed. The parts of a multipart feed device are preferably arranged above the treatment surface. In the case of at least two catches it is preferred according to the invention that these are arranged perpendicular to the feed direction next to each other in a distance, meaning that they lie in a common plane which is perpendicular to the transport direction, but that they must not necessarily be in a vertical orientation. More precisely, the catches preferably lie in a plane of which the normal consists exceptionally of components which point in feed direction. Therefore, the catches are preferably not arranged obliquely offset or even one after another. Each catch can have e.g. V- or U-shaped bifurcations at its end, so that optionally several contact areas or points exist which are assigned to a common catch. Furthermore, the possibly several catches of a part are preferably driven by the same drive element, what means that they are e.g. arranged at and moved by the same kinematics. Due to its catch arrangement, each part is thus suitable to contact the substrate preferably at its rear or in its back region located edge and to move it in feed direction. Particularly preferred, this contact engages symmetrically to the substrate; however, a feed can also be realized with an asymmetric application of force. Therefore, from the substrate's viewpoint, a pushing force preferably acts on the same at any time, whereas from the viewpoint of the individual parts of a multipart feed device, a pulling motion is possible, namely in particular if a part of the feed device being arranged in the region of the exit contacts a substrate at its rear which is still located in the middle of the treatment chamber. However, the forces acting onto the substrate are only compressive forces.

In order to prevent a collision of catches which are subsequently arranged in transport direction, the respective catches of the parts of a multipart feed device being comprised by a treatment chamber are spaced apart parallel to the feed direction and arranged in such a manner that a contact of the catches of adjacent parts is excluded, i.e. that they do not collide with catches of adjoining parts of the multipart feed device. In other words, the lateral distances of the respective catches are dimensioned such that subsequently arranged catches move either in between the preceding ones or around them, being able to take over the substrate without collision with other catches.

Particularly preferred, the catches are designed rod like and have ball or spherical segment like contact areas so that, as far as possible, between catch and substrate edge only a point or line contact, but not a surface contact occurs. Furthermore, the catches of a part are arranged at a common kinematics by which, in the course of the substrate contacting, the positioning of the contact areas with respect to the substrate edge is securely adjustable at any time during the treatment. In other words, the kinematics must be suitable for always properly adjusting the height of the contact areas with respect to the treatment plane. Preferably, link or joint motions which are known from the art can be used for this. This task can be solved particularly effectively with a parallelogram like kinematics. However, linear guides or robot guided devices are principally suitable for this purpose as well, but less preferred due to reasons of cost and complexity.

Further, the treatment chamber can optionally comprise at least one ultra- and/or megasound device. The same can be arranged in the region of the entry, of the exit, in the middle region, optionally above and/or below the treatment plane. Further, also several identical or different ultra- and/or megasound devices can be arranged in the treatment chamber, which can be oriented in parallel to the treatment plane, but which can also include an angle with the same. The ultra- and/or megasound devices can further be arranged stationary or movable in the treatment chamber. Furthermore, other treatment devices such as a gas treatment, an irradiation device, or inspection devices, can be provided as well.

It is further preferred that the media separation has a thin wall, as in particular a foil, being vertically arranged below the treatment plane in a catchment tank for the separation of treatment fluid. The treatment fluid originates from process chambers arranged one following another, and it is clear that the content of one process module shall not to be contaminated by the content of a preceding process module. The foil separates a catchment tank into two volumes, of which one is assigned to the preceding, the other is assigned to the subsequent process module. Advantageously, these volumes can be emptied separately, so that the respective content can be reused in the according treatment chamber.

It is also preferred that the devices for media separation each have at least one nozzle for the generation of a gas stream. Such a gas stream can fulfill several functions. In the case that the gas stream hits the surface of the substrate exact and directed, the gas stream serves for the wiping off of treatment liquid which adheres to the entering or exiting substrate. It shall be noted that herein, no Marangoni-effect is aimed for, since a complete drying of the substrate surface is neither necessary nor desired. In fact, a complete falling dry of the substrate surface is often damaging, since it can result in veils or the like which cannot be removed anymore. In the case that the gas stream hits the substrate surface softer and less directed, the same is suitable to effect a gas treatment of the substrate, e.g. a hydrophilisation of originally hydrophobic surfaces by means of gaseous ozone. It is therefore preferred that the media separation can at least also be operated with a treatment gas.

According to a preferred embodiment, several process modules are arranged one after another. Accordingly, a first process module can be combined with at least one further process module to form a process chain, wherein the (if applicable, respective) exit of the preceding process module can be coupled to the (if applicable, respective) entry of the subsequently (downstream) located process module, and wherein the respective treatment planes are arranged coplanar to each other. So, a process module can e.g. be used as chain link in a cleaning line.

According to a particularly preferred embodiment, the fluidic treatment relates to the transport as well as, if applicable, wet chemical treatments of flat substrates. The treatment can e.g. relate to all chemical processes which are common in wafer production, such as e.g. to a treatment with solutions of hydrofluoric acid (HF), hydrogen chloride (HCl), sulfuric acid (H₂SO₄), ozone (O₃), hydrogen peroxide (H₂O₂), ammoniac (NH₃), tetra methyl ammonium hydroxide (TMAH, N(CH₃)₄OH), as well as to mixtures of the same. Common mixtures are in particular HF/O₃, NH₃/H₂O₂ (so called SC1-solution), TMAH/H₂O₂, HF/H₂O₂, H₂SO₄/H₂O₂, HF/HCl, and HCl/H₂O₂ (so called SC2-solution), respectively being dissolved in a solvent. As solvent, water, and in particular, de-ionized water (DI-water), is preferably used. However, the treatment can also relate to a mere rinsing step with de-ionized water.

The invention further relates to a method for the fluidic in-line treatment of flat substrates by using the apparatus which is described in detail above. The following description is based on the example of at least two catches per part of a multi-, and in particular, a two-part feed device; the method according to the invention is of course also valid for parts which comprise only a single catch. According to the invention, a method comprises the following steps, whereby additionally, reference is made to the above mentioned descriptions of the components of the apparatus:

At first, it must be ensured that the substrate to be treated can be transported securely and free of damage. According to the invention, it is provided that a lower fluid cushion is formed on the (lower) treatment surface. According to the invention, this occurs by accordingly emitting fluid from the boreholes which are present in the treatment surface so that a sufficiently thick fluid layer can be developed.

Subsequently, the substrate is sufficiently far introduced through the entry opening into the treatment chamber, i.e. at least as far until the substrate is supported with its downward-facing side by the fluid layer of the fluid cushion without mechanically contacting the treatment surface. The introduction itself can therefore also be effected by others as by the means which are provided according to the invention; however, it is preferred that apparatuses are already being used also upstream, before the treatment chamber, which allow for a substrate transport that occurs according to the invention, and therefore, exceptionally gentle and controllable. The introduction has progressed sufficiently far when the taper of the substrate that follows the widest part of the same is at least slightly located in the interior of the treatment chamber. In other words, for example, the centre of a circular substrate would protrude at least slightly over the inner surface of the wall of the treatment chamber into the latter. Only then it is possible to further move the substrate into the treatment chamber with the feed device according to the invention.

Then, a control of the catches of a first part of a multipart feed device must take place in such a manner that a contact of the preferably rear or in the back region located edge of the substrate is established. As mentioned before, this is only possible if the substrate is located sufficiently far in the interior of the treatment chamber. For a detailed description of this step regarding circular or quadratic substrates, reference is made to the descriptions regarding the apparatus.

Then, the transport of the substrate by means of the catches of the first part of a multipart feed device can take place within the treatment chamber. According to the invention, the treatment of the substrate can take place on this path. It is of course also possible to interrupt the transport in order to e.g. enable a longer dwell period of the substrate in the treatment chamber. However, it is necessary according to the invention that during the entire time, a permanent contact between the catches and the substrate is present. According to the invention, this can be ensured by adjusting the vectors of the feed velocity and the flow velocity of the fluid cushion in such a manner that the component of the feed velocity in holding direction (as per definition given in the context of the description of the apparatus) exceeds the component of the flow velocity of the fluid cushion in holding direction. This can be achieved in several ways:

a) The catches contact the rear or in the back region located edge of the substrate, i.e. the edge which faces the entry, so that the holding direction roughly points from the entry to the exit. The flow velocity of the fluid cushion and the feed velocity each have a positive component in holding direction, wherein the respective component of the feed velocity in holding direction exceeds the respective component of the flow velocity of the fluid cushion in holding direction. For example, the feed velocity and the flow velocity of the fluid cushion can be equally directed (e.g. from the entry towards the exit). The permanent contact of the catches with the substrate edge which is necessary for the secure guiding of the substrate is achieved because the absolute value of the feed velocity exceeds the absolute value of the flow velocity of the fluid cushion.

b) The catches contact, as in case a), the rear or in the back region located edge of the substrate. The flow velocity of the fluid cushion has a negative component in holding direction, and the feed velocity has a positive component in holding direction. For example, the feed velocity and the flow velocity of the fluid cushion can be oppositely oriented. In this case, the rear substrate edge is always pushed against the catch(es) by the flow of the fluid cushion. The substrate is transported from the entry to the exit opposite to the flow direction of the fluid cushion by means of the catches.

c) The catches contact the front or in the front region located edge of the substrate, i.e. the edge which faces the exit, so that the holding direction roughly points from the exit to the entry. The flow velocity of the fluid cushion and the feed velocity both have a negative component in holding direction (e.g. directed from the entry to the exit), wherein the absolute value of the respective component of the flow velocity of the fluid cushion in holding direction exceeds the absolute value of the respective component of the feed velocity in holding direction. Considering the sign, also here, the component of the feed velocity in holding direction exceeds the component of the fluid velocity in holding direction. In this case, the substrate is transported by the flow of the fluid cushion from the entry in direction of the exit, wherein the catches act as stoppers at which the front substrate edge bears at anytime.

The cases a) to c) represent typical possibilities of application; however, the general principle is also valid for, with respect to the transport direction, inclined oriented directed up until perpendicularly oriented directed flow directions of the fluid cushion, for fluid cushions without flow, as well as for catches which are arranged asymmetrically with respect to the feed direction. The feed velocity and the flow velocity (direction and absolute value) can also vary within the treatment chamber depending on the actual position, wherein, however, the aforementioned general condition should always be met in order to ensure a secure guiding of the substrate by means of the catches.

Subsequently, a handing-over of the substrate to at least one further part of the feed device can take place, if the same has a multi-, as in particular, a two-part design. For this, the catches of both parts must be controlled in such a manner that the catches of the first part contact the edge of the substrate until this edge is also contacted by the catches of the further part. Therefore, the handing over as well as the taking over catches contact the substrate at least for a short moment, thus ensuring that an uncontrolled movement of the substrate does not occur at any time. In particular, the catches guide the substrate as well, thus avoiding a lateral breaking out of the same. A collision of the catches of different parts of the feed device during the handing-over of the substrate is excluded because the handing-over and the taking-over catches are, according to the invention, each spaced apart differently from the other in lateral direction.

After the completed handing-over, the further transport, of the substrate within the treatment chamber takes place by means of the catches of the further part of the multipart feed device. Of course, a treatment of the substrate can take place during this further transport as well. If desired, a stopping or reversing of the feed is possible as well as defined in the above description.

Finally, the substrate is sufficiently fed out of the exit opening from the treatment chamber. This feeding out is then sufficient when the taper of the substrate that follows the widest part of the same is at least slightly located outside of the treatment chamber. Therefore, this step must be seen in analogy with the aforementioned sufficient feeding in of the substrate into the treatment chamber. In the case that a further process module of the type according to the invention follows the process module, it can only take over the substrate if the substrate was, as described before, sufficiently far fed in into the same, which is equivalent to a sufficient feeding out of the substrate from the preceding process module.

According to a preferred embodiment, the method according to the invention further comprises also the separation of media which adheres to the incoming and/or exiting substrate, such as, in particular, treatment liquid, from an upstream arranged, or from the actual process module. For this, the use of the above described media separation device is particularly preferred. The step of media separation can be intended to take place before as well as after the actual treatment within the treatment chamber. Accordingly, an according number of media separation devices must be provided as well. Of course, normally, only one single media separation device must be provided in a sequence of process modules between them. A media separation device is not absolutely necessary if the same liquid is used in two subsequently arranged process modules.

As already indicated before, it is preferred that the method according to the invention further comprises optionally, beside the gentle and controller transport of the substrates according to the invention, one or several of the following steps:
a single sided or double sided treatment of the substrate with a treatment fluid;
a single sided or double sided treatment of the substrate with ultra- and/or megasound.

In the course of the treatment, the substrate can e.g. be modified as well as be cleaned. Also an inspection, for example by ultrasound or other imaging techniques, is to be included in the treatment as per definition. The ultra- and/or megasound treatment can preferably be carried out according to the above mentioned variants.

According to the invention, it is preferred if the substrate is fed out from the exit to such an extent, that the taper of the substrate that follows the widest part of the same is at least slightly located within the interior of a following process module. Therefore, this type of feeding out fulfills the criteria of the above described sufficient feeding out. However, according to the invention, it is also possible, although not preferred, to feed out the substrate less far out of the exit. This can always then be reasonable when an otherwise removal of the completely treated, and therefore less sensitive, substrates can take place after a last process module, for example by means of conveyor belts, grippers, or carrier devices which hold several substrates.

According to a further, preferred embodiment, the catches of a further part of a multipart feed device feed out a first substrate through the exit from the treatment chamber, while the catches of a first part of the multipart feed device feed in a second substrate through the entry into the process chamber. In this way, several substrates can be fed through the treatment chamber simultaneously, thus achieving a further improvement of the efficiency. By means of the separate controllability of the parts of the feed device it is also possible to already transport a substrate into the treatment chamber while a second substrate temporarily stands still in the interior of the treatment chamber. In this case it is only necessary to ensure that according catches are also available in time for the handing-over of a substrate. This can be achieved by timely feeding out the treated substrate from the treatment chamber, or also by providing further or additional parts of the multipart feed device.

According to a particularly preferred embodiment of the method according to the invention, at least the transfer velocities and, if applicable, also the feed velocities acting on the respective substrates and, if further applicable, the flow velocities of several subsequent process modules, are synchronized with each other. In this manner it is ensured that substrates which are fed out from an upstream arranged process module are handed over safely and controlled to the subsequently arranged process module. In particular, it is ensured that no collisions can take place due to piling up substrates, or due to catches being in unfavourable position.

### DESCRIPTION OF FIGURES

FIG. 1A shows the side cut view of a preferred embodiment of the process module according to the invention.

FIG. 1B shows a detail view of the entry region.

FIG. 2 shows the top view of a preferred embodiment of the process module according to the invention.

FIG. 3 shows the details of a preferred embodiment of the catches according to the invention.

FIG. 4 shows the details of a preferred embodiment of the media separation device according to the invention.

FIG. 5 shows a sequence of several preferred embodiments of process modules according to the invention with media separation devices arranged in between.

FIGS. 6A-D show the typical motion sequence of a preferred embodiment of the catches according to the invention during the feeding in, during the handing-over, and during the feeding out of a substrate in the course of the treatment by using a process module according to the invention.

FIGS. 7A-D represent the definition of the holding direction as well as of the preferred dependence between the holding direction and the vectors of the feed velocity and the fluid cushion's flow velocity.

FIG. 8A shows the top view on a treatment surface with catches which protrude from the same.

FIG. 8B shows a treatment surface according to FIG. 8A in a side view.

FIG. 9A shows the top view on a treatment surface with catches which protrude laterally into the region of the same.

FIG. 9B shows a treatment surface according to FIG. 9A in a side view.

FIG. 10A shows the top view on a treatment surface with catches which protrude from above into the region of the same.

FIG. 10B shows a treatment surface according to FIG. 10A in a side view.

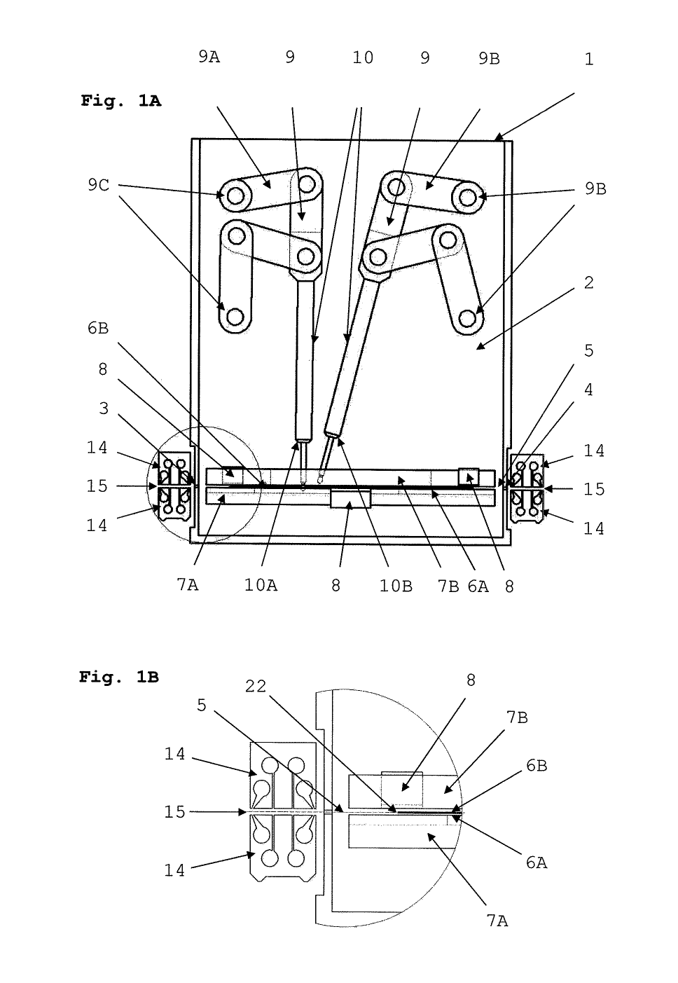

FIG. 1A depicts the side cut view of a preferred embodiment of the process module 1 according to the invention. FIG. 1B shows a detail view of the entry region. The process module 1 comprises a treatment chamber 2 having an entry 3 and an exit 4. The openings 3 and 4 are arranged in a common treatment plane 5 which extends through the entire treatment chamber 2.

According to the depicted embodiment, the treatment plane 5 is horizontally aligned. A respective lower or upper treatment surface 7A or 7B is arranged parallel to, and on both sides of, this treatment plane 5. In direction to the treatment plane 5, these respectively mark the boundary of a lower fluid cushion 6A being arranged below the treatment plane 5 and of an upper fluid cushion 6B being accordingly arranged above the treatment plane 5. Fluid can be emitted in direction of the treatment plane 5 by means of not depicted boreholes of the treatment surfaces 6A or 6b of the fluid cushions 7A and 7B, so that a layer of fluid develops on both sides of the treatment plane 5. The substrate is supported in the treatment plane 5 without mechanically contacting the lower or the upper treatment surface 7A or 7B, respectively, due to the flows which are directed against the surfaces of a substrate 22. In this way, a particularly gentle support of the substrate is ensured.

Several megasound devices 8 are also arranged in the region of the treatment plane 5. According to the depicted embodiment, these are arranged below and above the treatment plane 5 and are oriented parallel to the same. However, it can be provided in certain cases that the megasound devices 8 are arranged inclined at a certain angle with respect to the treatment plane 5 (not shown).

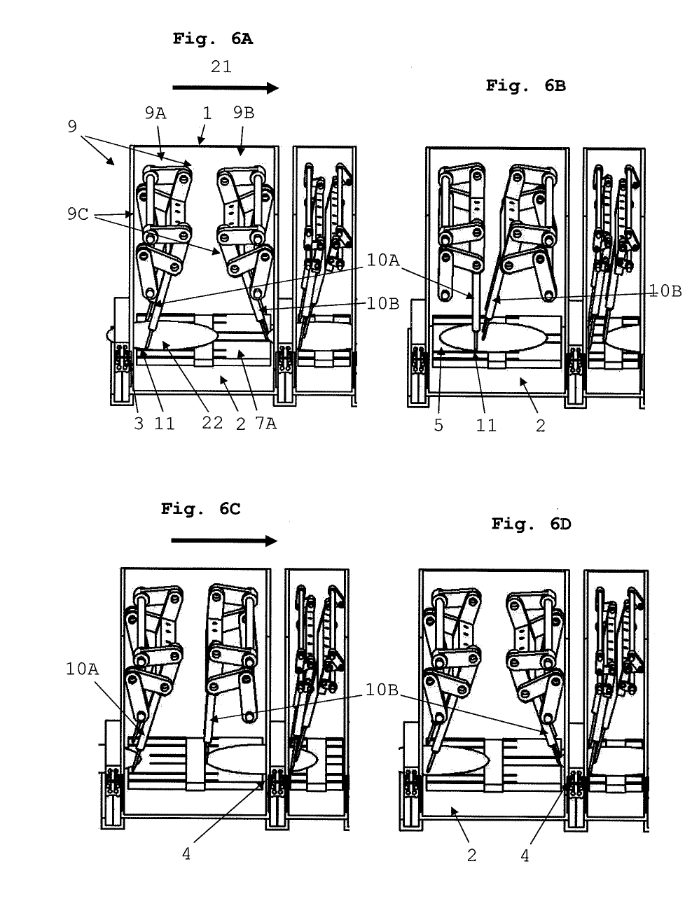

A further essential component of the depicted embodiment is a multi-, as in particular, a two-part designed device for the controlled feed 9 of the substrates having catches 10 (briefly: feed device) within the treatment chamber 2. According to the depicted embodiment, this device consists of a front part 9A and a rear part 9B that each comprise a kinematics 9C with joints. Accordingly, front catches 10A or rear catches 10B are respectively arranged at each kinematics 9C which have contact areas 11 at their end, which are arranged at least at any time during the handing-over of the feed to the substrates according to the invention at the level of the treatment plane 5 (refer to FIG. 6 in addition to the according description).

A media separation device 14 is respectively arranged in front of and behind the treatment chamber 2, wherein the former optionally serves for a treatment with an according (process) gas, or by which a separation of surplus fluid from the substrate can be achieved. The positioning at the entry 3 or the exit 4, respectively, is such that the separator gap 15 is substantially congruent with the treatment plane 5, so that incoming or exiting substrates must not be exposed to unnecessary loads due to lifting or lowering.

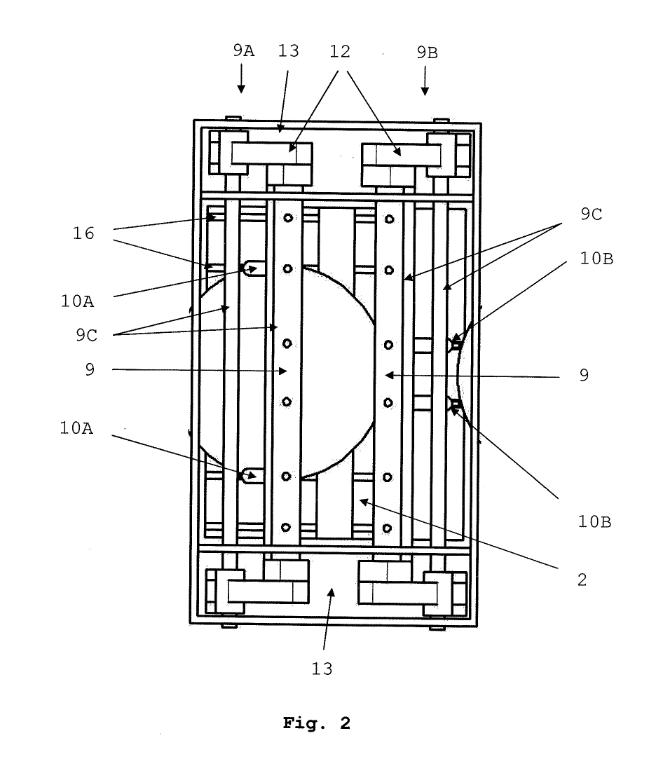

In FIG. 2, the top view of a preferred embodiment of the process module 1 according to the invention from FIG. 1 is depicted. Here, the drive elements 12 for the feed device 9 which are housed in a drive chamber 13 which is separated from the treatment chamber 2 are depicted, beside the components which have been readily described in this context and thus must not be described again herein. According shafts extend through the separation wall between treatment chamber 2 and drive chamber 13 for operation of the kinematics 9C. Not depicted is a preferably present flushing of the drive chamber 13 by which abrasion which is generated by the motion of the drive elements 12 can be removed before it reaches the treatment chamber through the openings to the same. For this, the treatment chamber is particularly preferable to be loaded with a negative pressure, so that the flushing fluid is drawn in by a not depicted inlet, and sucked off from an also not depicted outlet.

The different lateral spacing of the front catches 10A (left part of the picture), and the rear catches 10B (right part of the picture) is well visible. While the front catches 10A have a distance which amounts to approximately 80% of the substrate diameter, the rear catches 10B only have a distance of approx. 20% of the substrate diameter. In this way it can be ensured that no collision of the respective pairs of catches must be feared upon the rear catches gripping through between the front catches during handing-over of the substrate, since a contact of the catches 10A or 10B of respectively adjacent parts 9A or 9B of the feed device 9 is excluded. According to the depicted preferred embodiment, the catches 10 of a respective part of the multipart feed device 9 are aligned symmetrically to the substrate which is also depicted in this figure, contacting the same only on its edge which is located in its back region. According to a not depicted embodiment, the point of application can also lie asymmetrically to the substrate, and less or more catches can be provided for each part of the feed device 9. Further, the catches can reach to the edge of the substrate not only from above as shown, but also e.g. from the side and/or protruding from the treatment surface(s), thus pushing it forward. In the depicted case wherein the catches 10 reach from above to the substrate, according feedthrough slots 16 are provided in the upper treatment surface which lies above the treatment plane.

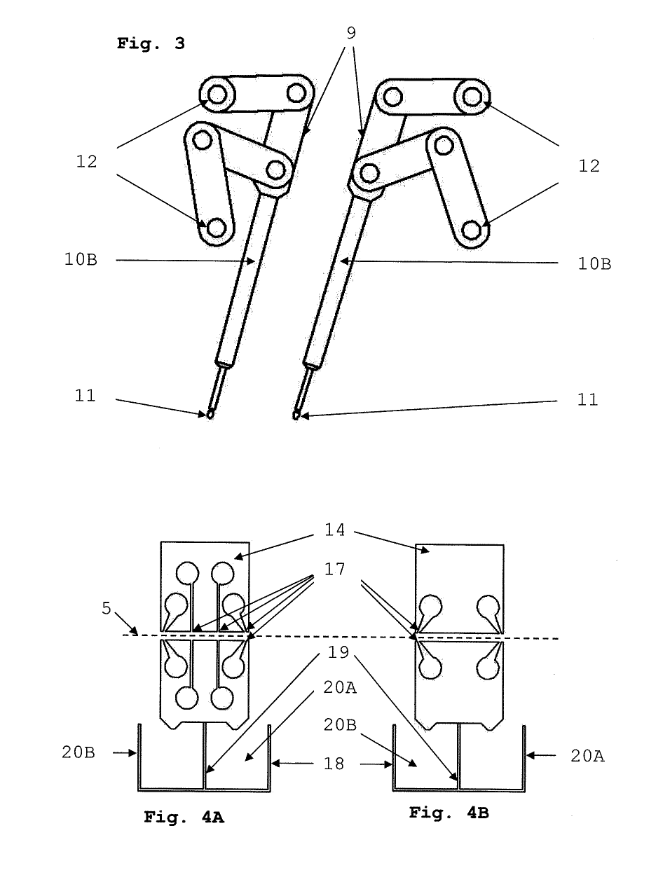

In FIG. 3, the details of a preferred embodiment of the catches 10 according to the invention are depicted. At a first end which is shown in the upper region of the picture, these have, in addition to drive elements 12, receivers which are provided as joint receivers for the kinematics 9C which moves them. The catches 10 have a rod like shape and carry contact areas 11 at their end which is located downwards in the picture, the contact areas 11 being provided for the mechanical contact with the substrate. The contact areas 11 are designed sphere shaped in order to minimize the contact area as far as possible. According to other, not depicted embodiments, they have a spherical, blade like, or cylinder like shape.

The FIGS. 4A and 4B show the details of a preferred embodiment of the media separation device 14 according to the invention. The same comprises several gas nozzles 17 which are directed to the surface of the substrate (not shown). Depending on the configuration of the gas nozzles 17, the gas jet can be softer or harsher. A soft jet is particularly suitable for a gas treatment of the substrate surface, for example by means of ozone for the hydrophilisation of the substrate. On the other hand, a harsh jet is preferably suitable for the wiping off of surplus fluid which still adheres to the substrate surface. According to a not depicted embodiment, a single media separation device 14 can also have several gas nozzles 17 which also can take over different tasks such as, for example, wiping off and hydrophilisation.

Further, the media separation device 14 has a catchment tank 18 being arranged below the treatment plane 5. According to the depicted embodiment, the same is separated by a vertically arranged thin wall (foil 19) into two semi-volumes, of which one is assigned to a not shown preceding, the other to a subsequent process module. Pouring down fluid which has been separated by the media separation device 14 will therefore run into that semi-volume 20A or 20B, respectively, which is turned to the respective treatment chamber 2 from which the fluid originates. Advantageously, the semi-volumes 20A/B can be emptied separately, so that the respective content can be reused in the according treatment chamber 2, for which according pumping devices must be provided (respectively not shown).

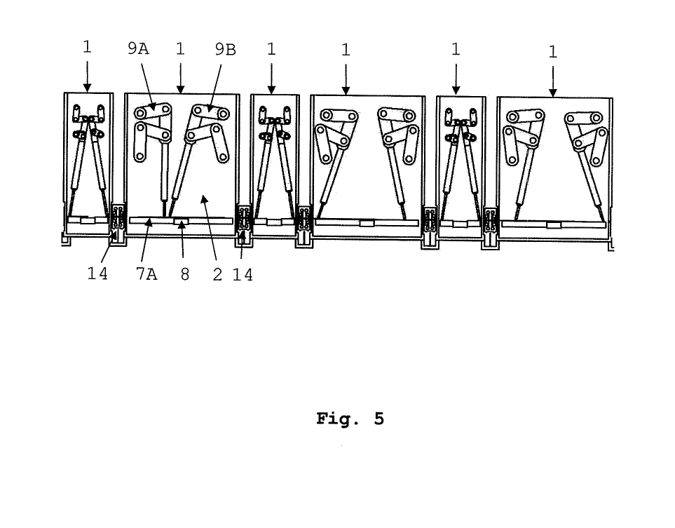

In FIG. 5, a sequence of several preferred embodiments of process modules 1 according to the invention with media separation devices 14 arranged in between is shown. For the sake of clarity, not all of the already above-described details are represented or provided with reference signs. For each process module 1, the treatment chamber 2, the lower treatment surface 7A with a megasound device 8, the front and rear feed device 9A, 9B, as well as the media separation device 14 are shown. As can be seen directly from the figure, it is only necessary that each process module 1 comprises only one single media separation device 14 in the case of subsequently arranged process modules 1. Herein, the first and the last process module 1 which can comprise, if desired, a further media separation device 14, are an exception. Particularly preferred, all process modules 1 have the same treatment plane 5, so that changing the same during the feed of a substrate through several process modules 1 can be omitted. Although not directly visible, it is clear herein that the feed and, if applicable, the flow velocity at least within neighbouring modules must be pitched to or synchronized with each other in such a manner that no collisions of the substrates can take place. However, the synchronization only relates to the handing-over of a substrate from one to a subsequent process module 1; the feed velocities within the treatment chambers 2 of different process modules 1 can differ from each other.

The FIGS. 6A-D show the typical motion sequence of a preferred embodiment of the catches 10 according to the invention during the feeding in, during the handing-over, and during the feeding out of a substrate in the course of the treatment by using a process module 1 according to the invention in a view diagonally from above. For the sake of clarity, nonrelevant components are omitted. Shown is the feed device 9 which consists of two parts 9A and 9B with the according front and rear catches 10A and 10B, as well as the according position of the kinematics 9C.

The FIG. 6A shows a process module 1 according to the invention, at the entry 3 of which a substrate 22 is located being arranged on the lower treatment surface 7A. It protrudes so far into the treatment chamber 2 that the taper of the substrate that follows the widest part of the same is at least slightly located inside of the treatment chamber 2. Since the substrate 22 is round, this means that the centre of the substrate has passed the interior of the wall of the entry 3.

The catches 10A which belong to the front part of the feed device 9A are positioned at that time in a manner such that their contact areas 11 contact the substrate's edge which is located in the back region. Herein, the feed direction 21 is indicated by the arrow.

In FIG. 68, the substrate 22 is already completely located in the interior of the treatment chamber 2. The front catches 10A have pushed forward the substrate roughly into the centre of the treatment chamber. The contact areas 11 are still located at the height of the rear edge of the substrate, and thus, in the treatment plane 5. The rear catches 10B which belong to the rear part of the feed device 9B grip through between the front catches 10A and are already located in the proximity of the edge which is located in the rear region of the substrate.

In FIG. 6C, the rear catches 10B have completely taken over the substrate from the front catches 10A which in turn do not contact the substrate anymore. Now, the rear catches 10B move the substrate further in feed direction 21, or in direction of the exit 4, respectively. They remain at the height of the treatment plane 5 at any time during the contact.

In FIG. 6D, the rear catches 10B have pushed the substrate so far out of the exit 4 of the treatment chamber 2, that the taper of the substrate that follows the widest part of the same is at least slightly located outside of the treatment chamber 2. In the case of a round substrate, this means that its centre has passed the wall of the exit 4. Particularly preferred, the rear catches 10B push the substrate as far as is possible out of the exit 4, so that it is fed into an optional subsequently arranged treatment chamber 2 of a further process module so far, that, in analogy to FIG. 6A, the front catches of the same can pushingly contact the edge of the substrate which is located in the rear region of the same, and that the motion sequence can repeat itself accordingly.

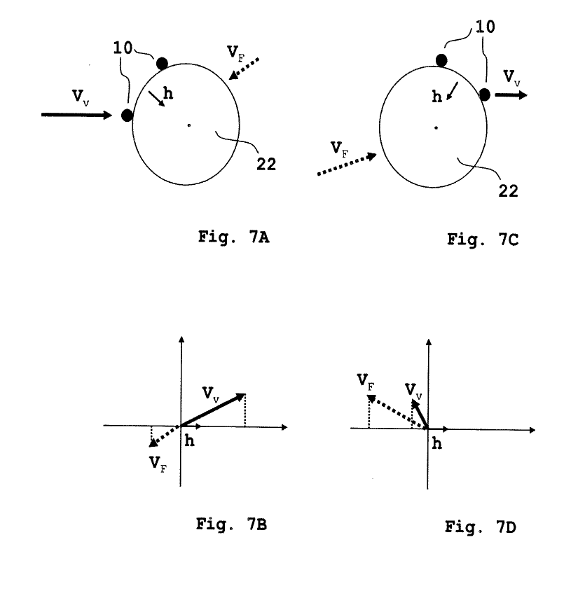

FIG. 7A-D represent the definition of the holding direction as well as the preferred dependence between the holding direction and the vectors of the feed velocity and the fluid cushion's flow velocity.

Therefore, the holding direction is to be understood as the direction of a vector representing the sum of those vectors which point from one respective catch in the plane of the substrate towards the centre of gravity of the substrate, as being depicted in FIGS. 7A to 7D. FIG. 7A and FIG. 7C schematically show a top view on two exemplary arrangements of a substrate 22 and two catches 10, wherein the vector of the holding direction h is also depicted. Thus, the holding direction h points always from the region of the substrate edge which the catch 10 touches to the centre of the substrate 22. In the case of several catches 10, the holding direction results from a vector addition of the respective single unit vectors. Thus, the holding direction also gives the direction in which forces can act from the catches onto the substrate.

FIGS. 7A and 7C show also exemplary vectors of the feed velocity V_{V} and of the flow velocity V_{F}.

FIGS. 7B and 7D show the according vectors in a polar coordinate system. The feed velocity V_{V}, i.e. the speed with which the feed device is being moved, as well as the flow velocity V_{F} of the fluid cushion, can have a component in direction of the holding direction h. If the holding direction and the according velocity component are identically directed (such as e.g. in the case of the feed velocity V_{V} in FIGS. 7A and 7B), the velocity component has a positive sign; if they are counter-directed (such as e.g. in the case of the flow velocity V_{F} in FIGS. 7A and 7B, as well as of the feed velocity V_{V} and the flow velocity V_{F} in FIGS. 7C and 7D), the velocity component has a negative sign. If the velocity is directed perpendicular to the holding direction, its component in holding direction is zero.

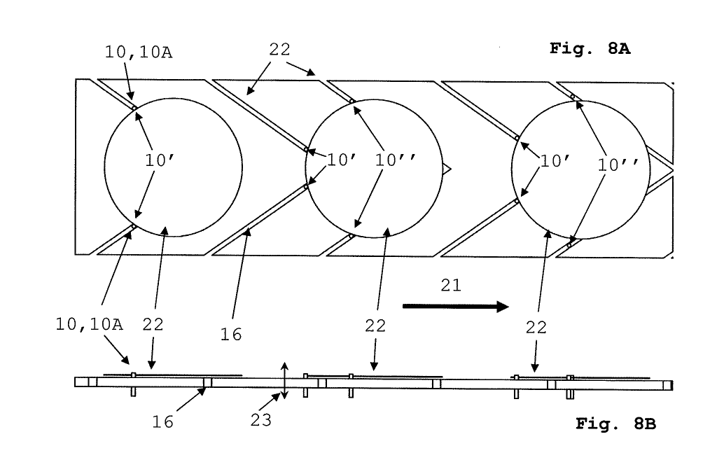

The FIG. 8A shows the top view on a treatment surface with catches which protrude from the same. The FIG. 8B shows a treatment surface according to FIG. 8A in a side view. For the sake of clarity, only the lower treatment plane 7A is shown on which several substrates 22 are located, as well as catches 10, of which only the front catches 10A are provided with reference signs. The catches 10, 10A protrude through the treatment surface 7A through feedthrough slots 16 of which also only two are provided with reference signs. The catches 10 are movably arranged in the feedthrough slots 16. A motion along the longitudinal axis of the feedthrough slots 16 as well as a motion running perpendicular to the treatment surface 7A is possible. Thus, the motion along the longitudinal axis of the feedthrough slots 16 results in a feed acting in transport direction 21 onto the rear edges of the substrates 22, and further in a progressive approach of a pair's of catches 10′ catches 10 towards each other. Thus, a pair of catches 10′ forms a part of the multipart feed device. In this case, a pair of catches 10′ consists of two catches 10 which each have the same position when viewed in transport direction 21. For example, this applies for the catches which are provided with reference signs 10A in FIG. 8A. In this way, it is possible to achieve a sufficiently far feeding out of a substrate 22 from the region of the treatment surface 7A despite the limited lengths of the last feedthrough slots 16 (shown in the right of the picture). The moveability of the catches 10, 10A which runs perpendicular to the treatment surface 7A, indicated by the arrow 23, serves for a return of the catches 10 to the initial position after handing-over of a substrate 22, without a substrate which is just located in the region of the respective feedthrough slot colliding with the returning catches. The initial position is characterized in that the catches of a pair of catches have the greatest possible distance to each other. According to the invention, the respective catches are arranged retracted in the treatment surface 7A during the return.

The situation which is respectively shown left-hand in the picture represents a substrate 22 which is transported by only one pair of catches 10′. The contact between the catches 10A and the substrate 22 acts on the rear edge of the substrate 22, wherein the catches 10A have already covered roughly half of the way along their respective feedthrough slot 16.

The situation which is respectively shown right-hand in the picture represents a substrate 22 just before the handing-over from one pair of catches 10′ to a subsequent pair of catches 10″. In this situation, the catches of a first pair of catches 10′ are not yet as close to each other as in the situation described hereinafter. The following catches 10″ are also not yet in contact with the rear edge of the substrate 22; however, the contact is imminent.

This situation which is respectively shown in the centre of the picture represents a substrate 22 during the handing-over from a first pair of catches 10′ to a pair of catches 10″ following the same. The substrate 22 has, for a short period, contact with both pairs of catches 10′, 10″. While the catches of the pair of catches 10′ which is located backwards when viewed in transport direction 21 are already in close proximity to each other, thus pushing the substrate 22 as far as is possible forward in transport direction 21, the still widely spaced apart catches of the subsequent pair of catches 10″ take over the substrate 22 by contacting accordingly far spaced apart points of the rear edge of the same. In this manner, a handing-over of the substrate 22 from one to a following pair of catches is possible without the pairs of catches 10′, 10″ colliding with each other.

The motion of the catches 10 of a pair of catches 10′ must therefore respectively be adjusted to the motion of the following pair of catches 10″ in order to ensure a handing-over according to the invention. In contrast, the motion of several subsequent pairs of catches can take place synchronized in groups. This means, that for example each third pair of catches executes the same motion, so that three groups are provided which are independent of each other. When, for example, the catches of the first group are just before the end of their path along the respective feedthrough slot 16, preparing the handing-over with the catches of the subsequent group, simultaneously, the members of the third group are being returned to their initial position in a retracted position, etc. In this way, the effort for the provision of the individual motions can be reduced.

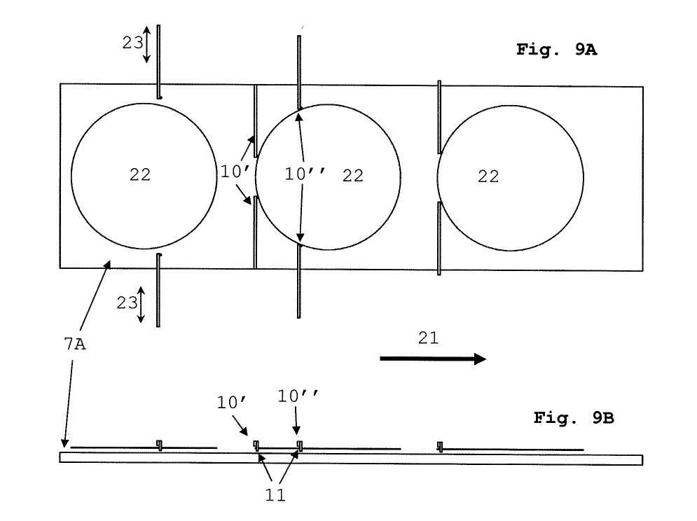

The FIG. 9A shows the top view on a treatment surface with catches which protrude laterally into the region of the same. The FIG. 9B shows a treatment surface according to FIG. 9A in a side view. As before in FIGS. 8A and 8B, only parts which are relevant for the description of the embodiment are shown, and redundant reference signs are omitted.

Again, the catches are, according to the invention, combined to pairs 10′, 10″, which form respective parts of the multipart feed device. It is visible in the side view (FIG. 9B) that the catches are also arranged above the lower treatment surface 7A as well as above the substrates 22. The contact areas 11 of the catches extend as far in direction of the treatment surface 7A, so that they can contact the edge of a substrate 22, whereas the remaining catch is spaced apart in vertical direction from the treatment surface 7A preferably so far until it cannot collide with the substrate 22.

On one hand, the catches are moveable in and against the transport direction 21 in order to be able to exert an accordingly directed feed to the substrates and subsequently to drive back in an initial position. This initial position is the position in which the catches are positioned as far as is possible against the transport direction. Further, the catches of a pair are also moveable towards each other, as indicated by the arrows 23. This motion corresponds to the motion shown in FIG. 8A, 8B, according to which the catches of a pair can move towards each other. Accordingly, an analogous effect can also be achieved with the catches according to the embodiment of FIG. 9A, 9B. Additionally, reference is made to the according above descriptions.

Shown in the centre of FIG. 9A, 9B, the situation in which a handing-over of a substrate from one pair of catches 10′ to a pair of catches 10″ following the same is shown. Because of the motion which is possible in transport direction 21 as well as in direction of the axes of the catches, a handing-over is made possible which takes place analogous to the handing-over process as described in FIG. 8. Therefore, reference is made again to the according above descriptions. The same applies for the pitching and synchronizing of the motions of individual pairs of catches.

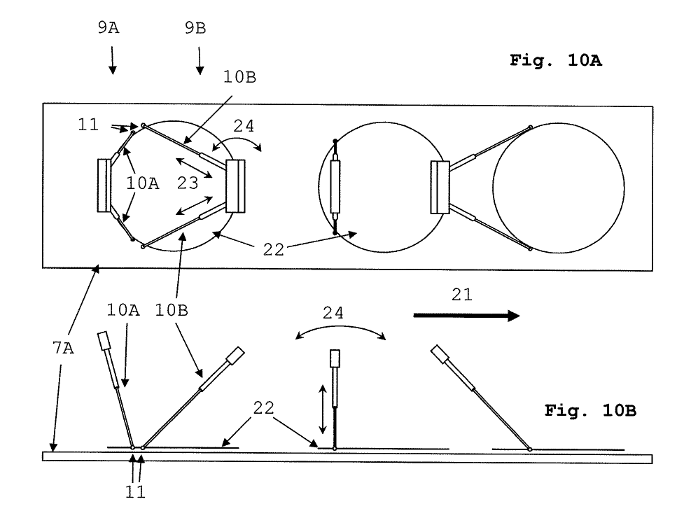

The FIG. 10A shows the top view on a treatment surface with catches which protrude from above into the region of the same. The FIG. 10B shows a treatment surface according to FIG. 10A in a side view. Again, redundant reference signs have been omitted for reasons of clarity.

According to this particularly preferred embodiment, the feed device is designed in such a manner that the respective catches 10A or 10B of a part 9A or 9B are structurally connected with each other. One front part 9A of a multipart feed device as well as a rear part 9B respectively exists with regard to a substrate 22. (From the viewpoint of a substrate 22 which follows the same, the rear part of the multipart feed device 9B would have to be indicated by 9A again, since it is located in front of this substrate when viewed from the same.) The catches are designed telescopic in order to ensure a permanent contact of the catches 10A, 10B with the respective substrate edge. This means that they can extend or contract themselves along their longitudinal axis, indicated by the arrows 23. In this way, it is ensured that the contact areas 11 of the catches 10A, 10B can always contact the edge of a substrate 22 at the height of the edge.

Respectively shown left-hand in the picture is the situation just before the handing-over of a substrate 22 from a front part 9A of the multipart feed device to a (from the viewpoint of the same substrate 22) rear part 9B of the multipart feed device. The catches 10A have a short length, so that their contact areas 11 are arranged in the plane of the substrate edge (treatment plane). The catches 10B have a greater length due to the same reason. This is particularly well visible in FIG. 10B (side view), in which for example the part that is arranged in the centre of the picture is aligned almost perpendicular to the treatment surface 7A, whereas the following part (right picture) includes an angle of approximately 45° with it. In order to be able to exert the feed according to the invention onto the respective substrate, the contact areas 11 of the catches 10A, 10B must be movable in transport direction 21. According to the invention, this is achieved in that each part 9A, 9B is additionally pivotable, as respectively indicated by the arrow 24. In this way, the catches 10A, 10B of the individual parts of a multipart feed device can take very different positions, so that the contact areas can take different positions along the transport direction 21 as well. For example, the situation which is respectively shown in the centre and right hand in FIG. 10A, 10B represents the transport of a substrate 22 which is only in contact with one pair of catches after the handing-over. The pair of catches which is shown right-hand in the picture is aligned and pivoted in such a manner that it can push the contacted substrate 22 as far as is possible in transport direction 21. In contrast, the catches of the part 10B contact the substrate which is arranged there with a (firstly) pulling motion which (later, not shown) will transform into a (from the viewpoint of the part 10B) pushing motion (not shown).

During the (not shown) return of the catches of a part, no contact exists with a substrate 22, which simply can be achieved in that the parts reduce their length until a collision with the substrates 22 is no longer possible during the return. Incidentally, what was said in the context of the precedent figures with regard to the pitching and synchronization of the motions of individual pairs of catches correspondingly applies.

The present invention was disclosed by the example of a process module with two parts of a feed device designed multipart. It is clear, that the invention can be realized also with a different number of such parts and catches according to or based on the aforementioned embodiments without leaving the scope of the invention.

It was further demonstrated that the invention provides a treatment under gentle and controllable transport of a substrate, wherein, in particular, the double sided treatment is possible without great efforts. The invention provides a treatment which is mostly free of undesired particles, and it fulfils in particular the requirements of high purity treatment processes as well. By means of the media separation device on one hand, and of the substrate supporting fluid cushion's flow which is preferably directed against the feed direction on the other hand, a carrying-over of treatment fluid, or a re-contamination of the substrate with already cleaned-away components, respectively, must not be feared.

### LIST OF REFERENCE SIGNS AND ABBREVIATIONS

1 process module

2 treatment chamber

3 entry, entry opening

4 exit, exit opening

5 treatment plane

6A lower fluid cushion

6B upper fluid cushion

7A lower treatment surface

7B upper treatment surface

8 mega sonic device

9 device for controlled feed, feed device

9A front part of a multipart feed device

9B rear part of a multipart feed device

9C kinematics

10 catch

10A front catch

10B rear catch

10′ first catch pair

10″ following catch pair

11 contact surfaces

12 drive elements

13 drive chamber

14 media separator

15 separator gap

16 feedthrough slots

17 gas nozzle, nozzle

18 catchment tank

19 foil

20A/B first/second semi-volume

21 feed direction, transport direction

22 substrate

23 arrow

24 arrow

V_{V} feed velocity

V_{F} flow velocity

h holding direction

1. Apparatus for the fluidic inline-treatment of a flat substrate (22) with at least one process module (1) that comprises a treatment chamber (2) having at least one treatment surface (7A) being substantially horizontally arranged in a treatment plane (5) and being designed for the formation of a lower fluid cushion (6A) provided to support the substrate (22) without mechanically contacting the treatment surface (7A), and at least one feed device (9) for the controlled feed of the substrate (22) in feed direction (21) comprising a first part (9A) and a further part (9B) which can be controlled separately and are, in feed direction (21), arranged apart from each other in such a manner that they are capable of simultaneously contacting the substrate's edge located in its back or front region thereby enabling handing-over of the substrate (22) from said first part (9A) to said further part (9B) of said feed device (9).

2. Apparatus according to claim 1, comprising means for adjusting the velocity of the feed (V_{V}) in such a manner that its component which points in holding direction (h) exceeds the component of the flow velocity (V_{F}) of the fluid cushion in holding direction (h), wherein the holding direction (h) is defined as the direction of a vector representing the sum of those vectors which point from one respective contacting of feed device and edge of a substrate (22) in the plane of the substrate (22) towards the centre of gravity of the substrate (22).

3. (canceled)

4. (canceled)

5. (canceled)

6. Apparatus according to claim 1, further comprising a further surface (7B) being arranged above and parallel to the treatment surface (7A) and being designed for the formation of an upper fluid cushion (6B).

7. Apparatus according to claim 1, further comprising a device for supplying the substrate side facing upwards with a second fluid.

8. Apparatus according to claim 1, wherein part (9A, 9B) of the feed device (9) has at least one catch (10, 10A, 10B) for contacting the edge of the substrate (22).

9. (canceled)

10. Apparatus according to claim 8, wherein the at least one catch (10, 10A, 10B) is designed to be rod like and to have a ball or spherical segment like contact area (11) and is arranged at a kinematics (9C) by which the positioning of the contact area (11), with respect to the substrate edge, can be securely adjusted and maintained at any time during the treatment and transport.

11. (canceled)

12. (canceled)

13. (canceled)

14. Method for the fluidic inline-treatment and transport of a flat substrate (22) by using the apparatus as defined in claim 1, comprising the following steps:
forming a lower fluid cushion (6A) on the treatment surface (7A) until the substrate (22) with its downward-facing side is supported by the fluid layer of the fluid cushion (6A) without mechanically contacting the treatment surface (7A),
contacting the substrate (22) with the first part (9A) of the feed device,
feeding of the substrate (22) by means of the first part (9A) of the feed device in feed direction (21) without mechanically contacting the treatment surface (7A),
handing over the substrate (22) from the first part (9A) to the further part (9B) of the feed device by contacting the edge of the substrate (22) with said further part (9B) such that both parts (9A, 9B), temporarily, contact the edge of the substrate, and
feeding the substrate (22) by means of said further part (9B) of the feed device in feed direction (21) without mechanically contacting the treatment surface (7A).

15. Method according to claim 24, wherein the first (9A) or second part (9B) contacts the rear or the in the back region located edge of the substrate (22), wherein the flow velocity (V_{F}) of the fluid cushion (6A, 6B) as well as the feed velocity (V_{V}) have a positive component in holding direction (h), and wherein the component of the feed velocity (V_{V}) is adjusted in such a manner that it exceeds the component of the flow velocity (V_{F}) of the fluid cushion (6A, 6B).

16. Method according to claim 24, wherein the first (9A) or second part (9B) contacts the rear or the in the back region located edge of the substrate (22), wherein the flow velocity (V_{F}) of the fluid cushion (6A, 6B) has a negative component in holding direction (h) and the feed velocity (V_{V}) has a positive component in holding direction (h).

17. Method according to claim 24, wherein the first (9A) or second part (9B) contacts the front or the in the front region located edge of the substrate (22), wherein the flow velocity (V_{F}) of the fluid cushion (6A, 6B) as well as the feed velocity (V_{V}) have a negative component in holding direction (h), and wherein the component of the flow velocity (V_{F}) of the fluid cushion (6A, 6B) is adjusted in such a manner that the magnitude of this component exceeds the magnitude of the component of the feed velocity (V_{V}) in holding direction (h).

18. (canceled)

19. Method according to claim 14, wherein the further part (9B) of the feed device (9) feeds out a first substrate (22) from the treatment chamber (2), while the the first part (9A) of the feed device (9) introduces a second substrate (22) into the treatment chamber (2).

20. (canceled)

21. (canceled)

22. Method according to claim 14, wherein the substrate (22) is fed out from a process module (1) so far until the taper of the substrate (22) that follows the widest part of the same is at least slightly located within the interior of a following process module (1).

23. (canceled)

24. Method according to claim 14, wherein the component of the feed velocity (V_{V}) in holding direction (h) exceeds the component of the flow velocity (V_{F}) of the fluid cushion (6A, 6B) in holding direction (h), wherein the holding direction (h) is defined as the direction of a vector representing the sum of those vectors which point from one respective contacting of feed device and edge of a substrate (22) in the plane of the substrate (22) towards the centre of gravity of said substrate (22).
